(19) United States
(12) Patent Application Publication
(10) Pub. No.: US 2023/0274015 A1
(43) Pub. Date: Aug. 31, 2023

(54) MANAGEMENT DEVICE, ENCRYPTION TERMINAL, USER TERMINAL, ENCRYPTION SYSTEM, MANAGEMENT METHOD, ENCRYPTION METHOD, AND COMPUTER-READABLE MEDIUM

(71) Applicants: NEC Corporation, Minato-ku, Tokyo (JP); NEC Solution Innovators, Ltd., Koto-ku,Tokyo (JP)

(72) Inventors: Takumi Hirota, Tokyo (JP); Kiminari Ohmura, Tokyo (JP)

(73) Assignees: NEC Corporation, Minato-ku, Tokyo (JP); NEC Solution Innovators, Ltd., Koto-ku,Tokyo (JP)

(21) Appl. No.: 18/009,048

(22) PCT Filed: Jun. 11, 2020
(86) PCT No.: PCT/JP2020/023084

§ 371 Date: Dec. 8, 2022

(51) Int. Cl. G06F 21/62; G06F 21/60

(52) U.S. Cl. CPC G06F 21/6218; G06F 21/602

(57) ABSTRACT

According to an example embodiment, a management server includes a monitoring means that monitors whether a file before encryption has been saved in a storage area managed by a file server, and an encryption instruction means that instructs, when the monitoring means detects that the file before encryption has been saved in the storage area, an encryption terminal to encrypt the file.

### TECHNICAL FIELD

The present invention relates to a management device, an encryption terminal, a user terminal, an encryption system, a management method, an encryption method, and a computer-readable media.

### BACKGROUND ART

There is no end to the number of security incidents in which confidential information is stolen by viruses (targeted attacks) and leaked to outside parties. Anti-virus measures and closing holes in information leakage routes are not sufficient for a risk of failing to respond to new attacks that occur daily. Therefore, it is important to take measures based on the assumption that information will be leaked, that is, file encryption measures to protect information (files) by encrypting the information itself.

A technique related to file encryption is disclosed in, for example, Patent Literature 1. The file management device disclosed in Patent Literature 1 includes an event acquisition unit, a file determination unit, an information writing unit, and a processing execution unit. The event acquisition unit acquires an event that occurs when the status of a file saved in a file server or the like changes. The file determination unit determines whether the file corresponding to the event is in plain text. When the file is determined to be in plain text, the information writing unit writes target file information that designates the file as the target of an encryption process to the storage device. When the target file information has been written to the storage device, the processing execution unit performs the encryption process on the file designated by the target file information.

### CITATION LIST

### Patent Literature

Patent Literature 1: Japanese Unexamined Patent Application Publication No. 2007-334577

### SUMMARY OF INVENTION

### Technical Problem

In recent years, in an encryption system that encrypts files saved on file servers, a management server in an external environment, such as a cloud service, is sometimes provided as a management server that manages file encryption. If the file management device (management server) disclosed in Patent Literature 1 is installed in this encryption system, the file management device needs to take files saved on the file server to the outside environment in order for the file management device to perform the encryption process. Therefore, the configuration disclosed in Patent Literature 1 can have a risk of leaking the files of a customer operating the encryption system. In other words, the configuration disclosed in Patent Literature 1 has a problem of being not able to improve confidentiality.

The present disclosure has been made to solve such a problem, and a purpose of the present disclosure is to provide a management device, an encryption terminal, a user terminal, an encryption system, a management method, an encryption method, and a computer-readable medium that are capable of improving confidentiality.

### Solution to Problem

A management device according to the present disclosure includes a monitoring means for monitoring whether a file before encryption has been saved in a storage area managed by a file server, and an encryption instruction means for instructing, when the monitoring means detects that the file before encryption has been saved in the storage area, an encryption terminal to encrypt the file.

An encryption terminal according to the present disclosure includes an instruction acceptance means for accepting, in response to a file before encryption having been saved in a storage area managed by a file server, an instruction to encrypt the file transmitted together with an encryption key from a management device, a file acquisition means for acquiring the file from the file server, an encryption means for encrypting the file with the encryption key, and a file output means for rewriting the file before encryption saved in the storage area to the file encrypted by the encryption means.

A management device according to the present disclosure includes a monitoring means for monitoring whether a user terminal has transmitted a notice that a file is to be saved in a storage area managed by a file server, and an encryption instruction means for instructing, when the monitoring means detects the user terminal has transmitted the notice, the user terminal to encrypt the file after transmitting an encryption key for encrypting the file.

A user terminal according to the present disclosure includes a notifying means for giving notice that a file is to be saved in a storage area managed by a file server, an instruction acceptance means for accepting an instruction to encrypt the file transmitted together with an encryption key from the management device in response to the notice by the notifying means, an encryption means for encrypting the file with the encryption key, and a file output means for saving the file encrypted by the encryption means in the storage area.

A management method according to the present disclosure includes a monitoring step of monitoring whether a file before encryption has been saved in a storage area managed by a file server, and an encryption instruction step of instructing, when it is detected that the file before encryption has been saved in the storage area in the monitoring step, an encryption terminal to encrypt the file.

An encryption method according to the present disclosure includes an instruction acceptance step of accepting, in response to a file before encryption having been saved in a storage area managed by a file server, an instruction to encrypt the file transmitted together with an encryption key from a management device, a file acquisition step of acquiring the file from the file server, an encryption step of encrypting the file with the encryption key, and a file output step of rewriting the file before encryption saved in the storage area to the file encrypted in the encryption step.

A non-transitory computer-readable medium according to the present disclosure stores a program to execute a monitoring process of monitoring whether a file before encryption has been saved in a storage area managed by a file server, and an encryption instruction process of instructing, when it is detected that the file before encryption has been saved in the storage area in the monitoring process, an encryption terminal to encrypt the file.

A non-transitory computer-readable medium according to the present disclosure stores a program to execute an instruction acceptance process of accepting, in response to a file before encryption having been saved in a storage area managed by a file server, an instruction to encrypt the file transmitted together with an encryption key from a management device, a file acquisition process of acquiring the file from the file server, an encryption process of encrypting the file with the encryption key, and a file output process of rewriting the file before encryption saved in the storage area to the file encrypted in the encryption process.

### Advantageous Effects of Invention

According to the present disclosure, it is possible to provide a management device, an encryption terminal, a user terminal, an encryption system, a management method, an encryption method, and a computer-readable medium that are capable of improving confidentiality.

### BRIEF DESCRIPTION OF DRAWINGS

FIG. 1 is a block diagram showing a configuration example of a management server provided in an encryption system according to a first example embodiment;

FIG. 2 is a block diagram showing a configuration example of an encryption terminal provided in the encryption system according to the first example embodiment;

FIG. 3 is a flowchart showing an operation of the management server shown in FIG. 1;

FIG. 4 is a flowchart showing an operation of the encryption terminal shown in FIG. 2;

FIG. 5 is a block diagram showing a configuration example of an encryption system according to a second example embodiment;

FIG. 6 is a sequence diagram showing a processing procedure of the encryption system shown in FIG. 5;

FIG. 7 is a sequence diagram shows the processing procedure of the encryption system shown in FIG. 5;

FIG. 8 is a block diagram showing a modified example of the encryption system shown in FIG. 5;

FIG. 9 is a sequence diagram showing a processing procedure of the encryption system shown in FIG. 8;

FIG. 10 is a sequence diagram showing the processing procedure of the encryption system shown in FIG. 8;

FIG. 11 is a block diagram showing a configuration example of an encryption system according to a third example embodiment;

FIG. 12 is a block diagram showing a configuration example of an encryption processing unit provided in a user terminal of the encryption system according to the third example embodiment;

FIG. 13 is a sequence diagram showing a processing procedure of the encryption system shown in FIG. 11; and

FIG. 14 is a sequence diagram showing the processing procedure of the encryption system shown in FIG. 11.

### EXAMPLE EMBODIMENT

Specific example embodiments will be described hereinafter in detail with reference to the drawings. The same or corresponding elements are denoted by the same reference signs throughout the drawings, and duplicated explanations are omitted as necessary for the sake of clarity.

### First Example Embodiment

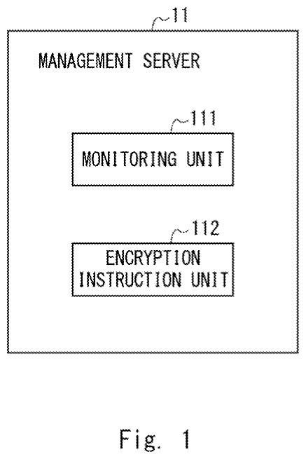

FIG. 1 is a block diagram showing a configuration example of a management server (management device) 11 provided in an encryption system according to a first example embodiment. The management server 11 according to the present disclosure manages encryption of a file saved on a file server and instructs, when a file before encryption (pre-encryption file) has been saved on the file server, an encryption terminal to encrypt the file without encrypting the file by itself. This prevents files from being taken from the file server to an external environment (the management server 11), even if the management server 11 is a management server in an external environment such as a cloud service, thereby improving confidentiality. The following is a specific description.

As shown in FIG. 1, the management server 11 includes a monitoring unit (monitoring means) 111 and an encryption instruction unit (encryption instruction means) 112. The management server 11 is connected via a wired or wireless network 16 to a storage unit (storage means) 12, a file server 13, a user terminal 14, and an encryption terminal 15 (all not shown).

The storage unit 12 stores information on the user terminal 14 for which the connection with the management server 11 has been established, and key information. The key information includes encryption keys for encrypting files and decryption keys for decrypting encrypted files. The storage unit 12 may be provided inside the management server 11.

The file server 13 manages files saved in a storage area provided inside or outside the file server 13 and the access privileges of the files. In the storage area managed by the file server 13, a file is stored in association with its file ID, saving location, and access privilege information. The storage area managed by the file server 13 is not limited to a storage area in a closed network environment such as an in-house network, but also includes a cloud storage. The storage area also includes local disks and the like.

The user terminal 14 is configured to be able to save (move or duplicate) a pre-encryption file in the storage area managed by the file server 13. The user terminal 14 is a personal computer (PC), a cell phone terminal, a smartphone, a tablet terminal, or the like and is assigned to, for example, an employee of a company that operates the encryption system.

In the management server 11, the monitoring unit 111 monitors whether a pre-encryption file has been saved in the storage area managed by the file server 13.

For example, the monitoring unit 111 may monitor whether a pre-encryption file has been saved in the storage area managed by the file server 13 periodically or at a timing when an event occurs in the file server 13. Alternatively, if the file server 13 has a function of sending a notification indicating that a pre-encryption file has been saved, the monitoring unit 111 may monitor whether a pre-encryption file has been saved in the storage area managed by the file server 13 according to the notification from the file server 13.

When detecting that a pre-encryption file has been saved in the storage area managed by the file server 13, the monitoring unit 111 acquires the ID of the user who has saved the pre-encryption file (the ID of the user terminal), the saving location of the file, and the file ID.

In the management server 11, when the monitoring unit 111 detects that a pre-encryption file has been saved in the storage area managed by the file server 13, the encryption instruction unit 112 instructs the encryption terminal 15 to encrypt the pre-encryption file. At this time, the encryption instruction unit 112 also transmits an encryption key for encrypting the pre-encryption file to the encryption terminal 15.

The encryption terminal 15 acquires the pre-encryption file from the file server 13, encrypts the acquired file, and then outputs it to the storage source of the pre-encryption file. This rewrites the pre-encryption file to the encrypted file.

### (Configuration Example of Encryption Terminal 15)

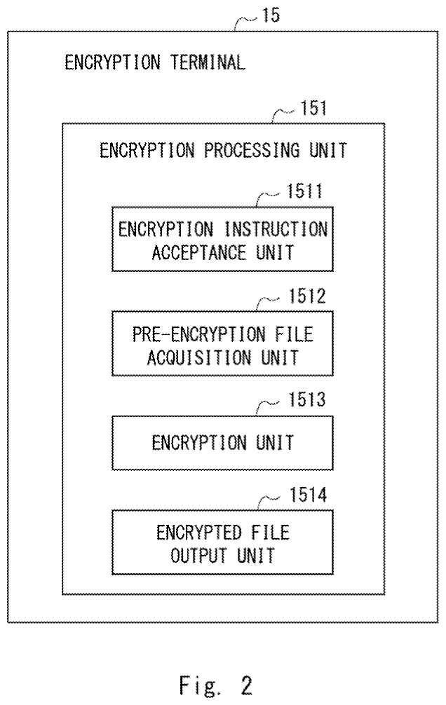

FIG. 2 is a block diagram showing a configuration example of the encryption terminals 15.

As shown in FIG. 2, the encryption terminal 15 includes an encryption processing unit 151. The encryption processing unit 151 includes an encryption instruction acceptance unit 1511, a pre-encryption file acquisition unit 1512, an encryption unit 1513, and an encrypted file output unit 1514.

The encryption instruction acceptance unit 1511 accepts an instruction to encrypt the pre-encryption file transmitted together with the encryption key from the management server 11. When the encryption instruction acceptance unit 1511 accepts the instruction to encrypt the pre-encryption file from the management server 11, the pre-encryption file acquisition unit 1512 acquires the pre-encryption file from the file server 13. The encryption unit 1513 encrypts the pre-encryption file acquired by the pre-encryption file acquisition unit 1512 with the encryption key received from the management server 11. The encrypted file output unit 1514 outputs the file encrypted by the encryption unit 1513 to the storage source of the pre-encryption file. This rewrites the pre-encryption file to the encrypted file.

### (Operation of Management Server 11)

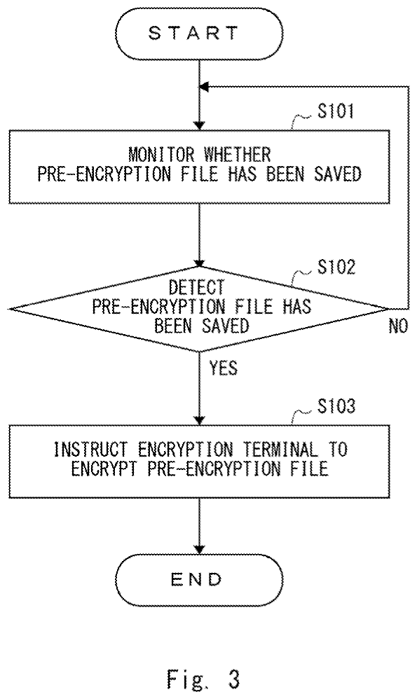

Next, an operation of the management server 11 is described with reference to FIG. 3.

FIG. 3 is a flowchart showing the operation of the management server 11.

The following description is an example in which a user U1 has saved, via the user terminal 14, a pre-encryption file f1_pre in a folder FD1, which is a part of the storage area managed by the file server 13.

In the management server 11, the monitoring unit 111 monitors whether a pre-encryption file has been saved (moved or duplicated) in the storage area managed by the file server 13 (step S101).

When detecting that a pre-encryption file has been saved in the storage area managed by the file server 13 (YES in step S102), the monitoring unit 111 acquires the ID of the user who has saved the file, the saving location of the file, and the file ID.

In this example, the monitoring unit 111 acquires the ID of the file f1_pre as the file ID, information on the folder FD1 as the saving location of the file f1_pre, and the ID of the user U1 as the ID of the user who has saved the file f1_pre.

Then, the encryption instruction unit 112 instructs the encryption terminal 15 to encrypt the file f1_pre (step S103). At this time, the encryption instruction unit 112 also transmits the encryption key for encrypting the file f1_pre to the encryption terminal 15.

### (Operation of Encryption Terminal 15)

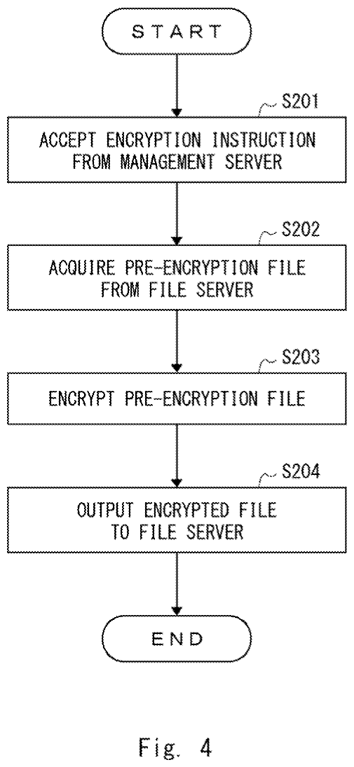

Next, an operation of the encryption terminal 15 is described with reference to FIG. 4.

FIG. 4 is a flowchart showing a processing procedure of the encryption terminals 15.

In the encryption terminal 15, the encryption instruction acceptance unit 1511 accepts an instruction to encrypt the pre-encryption file transmitted together with the encryption key from the management server 11 (step S201).

Then, the pre-encryption file acquisition unit 1512 acquires the pre-encryption file from the file server 13 (step S202). In this example, the pre-encryption file acquisition unit 1512 acquires the pre-encryption file f1_pre from the folder FD1.

Then, the encryption unit 1513 encrypts the pre-encryption file acquired by the pre-encryption file acquisition unit 1512 with the encryption key received from the management server 11 (step S203). In this example, the encryption unit 1513 encrypts the file f1_pre to generate an encrypted file f1.

Then, the encrypted file output unit 1514 outputs the file encrypted by the encryption unit 1513 to the storage source of the pre-encryption file. This rewrites the pre-encryption file to the encrypted file (step S204). In this example, the encrypted file output unit 1514 outputs the encrypted file f1 to the folder FD1 managed by the file server 13. This rewrites the pre-encryption file f1_pre to the encrypted file f1.

In this manner, when a pre-encryption file has been saved on the file server 13, the management server 11 according to the present example embodiment does not encrypt the file by itself, but instructs the encryption terminal 15 to encrypt the file. This prevents files from being taken from the file server 13 to an external environment (the management server 11), even if the management server 11 is a management server in an external environment such as a cloud service, thereby improving confidentiality.

Note that the management server 11 includes a processor, a memory, and a storage device that are not shown in the drawings. In addition, the storage device stores a computer program in which the processing of the management server 11 according to the present example embodiment is implemented. Then, the processor loads the computer program from the storage device into the memory and executes the computer program. The processor thereby implements the functions of the monitoring unit 111, and the encryption instruction unit 112.

Alternatively, the monitoring unit 111 and the encryption instruction unit 112 each may be implemented by dedicated hardware. In addition, a part or all of the constituent elements of each device may be implemented by a general-purpose or dedicated circuitry, a processor, or the like or a combination thereof. These may be configured by a single chip or a plurality of chips connected via a bus. A part or all of the constituent elements of each device may be implemented by a combination of the circuitry or the like described above and a program. In addition, as a processor, a central processing unit (CPU), a graphics processing unit (GPU), a field-programmable gate array (FPGA) or the like can be used.

If a part or all of the constituent elements of the management server 11 are implemented by a plurality of information processing devices, circuitries, or the like, the plurality of information processing devices, circuitries, or the like may be collectively or dispersedly arranged. For example, the information processing devices, circuitries, or the like may be implemented by being connected with each other via a communication network, such as a client server system or a cloud computing system. In addition, the function of the management server 11 may be provided in a form of Software as a Service (SaaS).

### Second Example Embodiment

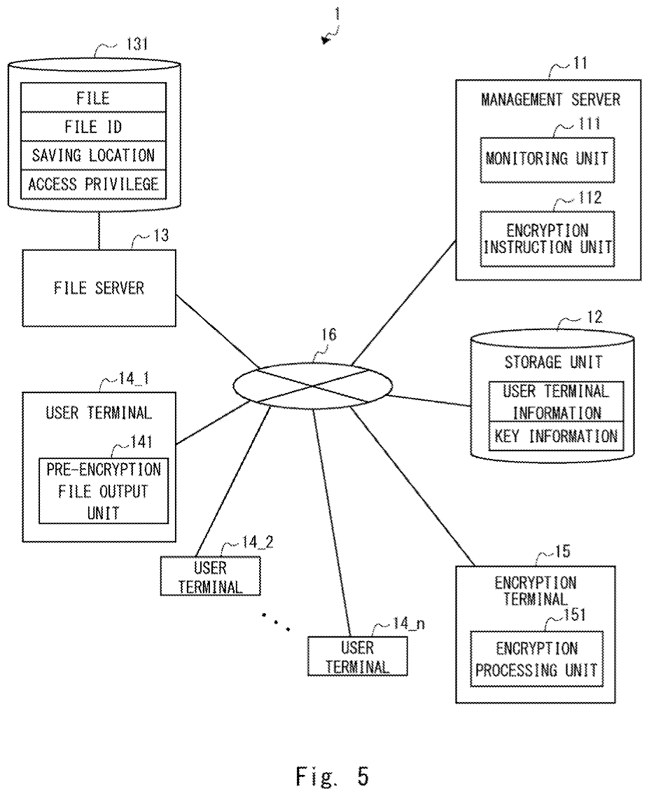

FIG. 5 is a block diagram showing a configuration example of an encryption system 1 according to a second example embodiment.

As shown in FIG. 5, the encryption system 1 includes a management server (management device) 11, a storage unit 12, a file server 13, n-number of user terminals 14 (n is an integer greater than or equal to 1), and an encryption terminals 15. The management server 11, the storage unit 12, the file server 13, the n-number of user terminals 14, and the encryption terminal 15 are connected with each other via a network 16. In the following, the n-number of user terminals 14 are referred to as user terminals 14_1 to 14_n to distinguish them from each other.

The storage unit 12 stores information on a user terminal 14 for which the connection with the management server 11 has been established, and key information. The key information includes encryption keys for encrypting files and decryption keys for decrypting encrypted files. The storage unit 12 may be provided inside the management server 11.

The file server 13 manages files saved in a storage area 131 provided inside or outside the file server 13 and the access privileges of the files. In the storage area 131 managed by the file server 13, a file is stored in association with its file ID, saving location, and access privilege information. The storage area 131 managed by the file server 13 is not limited to a storage area in a closed network environment such as an in-house network, but also includes a cloud storage. The storage area also includes local disks and the like.

Each of the user terminals 14_1 to 14_n includes a pre-encryption file output unit 141 and is configured to be able to save (move or duplicate) a pre-encryption file in the storage area 131 managed by the file server 13. Each of the user terminals 14_1 to 14_n is a PC, a cell phone terminal, a smartphone, a tablet terminal, or the like and is assigned to, for example, an employee of a company that operates the encryption system 1.

The management server 11 manages encryption of a pre-encryption file saved in the storage area 131 managed by the file server 13. The constituent elements of the management server 11 have already been described.

The encryption terminal 15 performs an encryption process on a pre-encryption file saved in the storage area 131 in response to an instruction from the management server 11. The constituent elements of the encryption terminal 15 have already been described.

### (Operation of Encryption System 1)

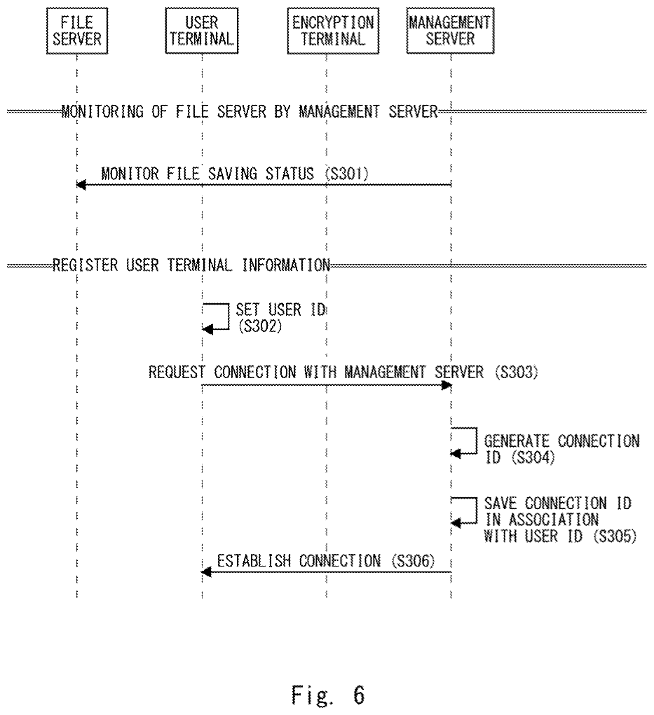

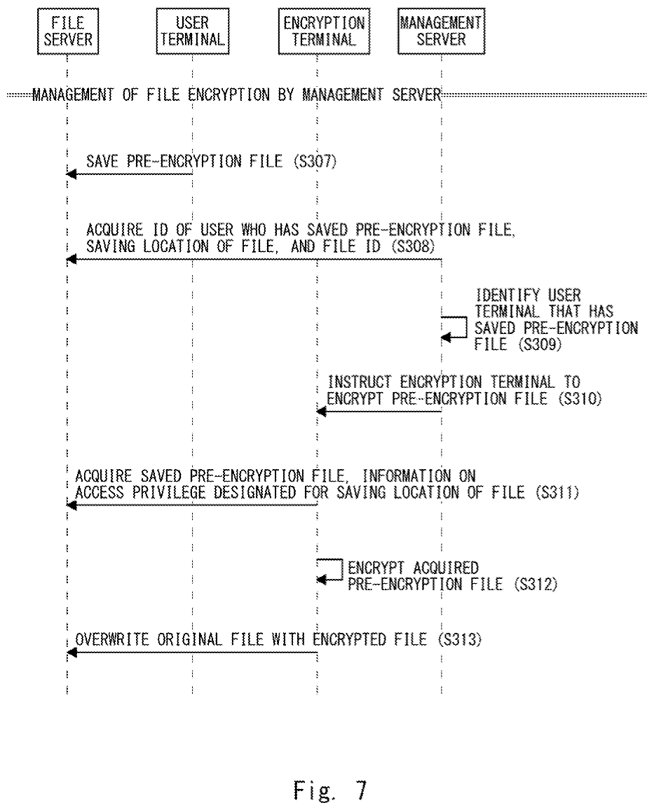

Next, an operation of the encryption system 1 is described with reference to FIGS. 6 and 7 in addition to FIG. 5.

FIGS. 6 and 7 are sequence diagrams showing the operation of the encryption system 1.

First, a process of “monitoring of the file server 13 by the management server 11” is described.

The management server 11 monitors the status of a pre-encryption file saved in the storage area 131 managed by the file server 13 during startup (step S301).

The management server 11 may monitor whether a pre-encryption file has been saved in the storage area 131 managed by the file server 13 periodically or at a timing when an event occurs in the file server 13. Alternatively, if the file server 13 has a function of sending a notification indicating the status of a saved pre-encryption file, the management server 11 may monitor the status of a saved pre-encryption file according to the notification from the file server 13.

Next, a process of “registration of user terminal information” is described.

The information on each of the user terminals 14_1 to 14_n is, for example, the ID of the user who owns the terminal, or the like.

Specifically, first, the user ID is initially set to the encryption system 1 (step S302). The user ID at this time may be the user ID logged in to each of the user terminals 14_1 to 14_n.

Then, each of the user terminals 14_1 to 14_n requests a connection with the management server 11 (step S303). In response to this, the management server 11 generates a connection ID for each of the user terminals 14_1 to 14_n (step S304) and saves the connection ID in the storage unit 12 in association with the user ID (step S305).

Then, the management server 11 establishes a connection with each of the user terminals 14_1 to 14_n (step S306).

Next, a process of “management of file encryption by the management server 11” is described.

The following description is an example in which a user U1 has saved, via the user terminal 14_1, a pre-encryption file f1_pre in a folder FD1, which is a part of the storage area 131 managed by the file server 13.

First, the user U1 saves, via the user terminal 14_1, the pre-encryption file f1_pre in the folder FD1, which is a part of the storage area 131 managed by the file server 13 (step S307).

When detecting that a pre-encryption file has been saved in the storage area 131 managed by the file server 13, the management server 11 acquires the ID of the user who has saved the file, the saving location of the file, and the file ID (step S308).

In this example, the management server 11 acquires the ID of the file f1_pre as the file ID, information on the folder FD1 as the saving location of the file f1_pre, and the ID of the user U1 as the ID of the user who has saved the file f1_pre.

Then, the management server 11 identifies the user terminal 14_1 from the ID of the user who has saved the file f1_pre (step S309). Then, the management server 11 instructs the encryption terminal 15 to encrypt the file f1_pre (step S310). At this time, the management server 11 also transmits the encryption key for encrypting the file f1_pre to the encryption terminal 15.

When receiving the instruction to encrypt the file f1_pre, the encryption terminal 15 acquires the file f1_pre and information on the access privilege designated for the folder FD1, which is the saving location of the file f1_pre, from the file server 13 (step S311).

Then, the encryption terminal 15 encrypts the file f1_pre acquired from the file server 13 with the encryption key received from the management server 11 (step S312). In this example, the encryption terminal 15 encrypts the file f1_pre to generate an encrypted file f1.

Then, the encryption terminal 15 outputs the encrypted file f1 to the folder FD1, which is the storage source of the pre-encryption file f1_pre. The pre-encryption file f1_pre is thereby rewritten by the encrypted file f1 (step S313).

In this manner, in the encryption system 1 according to the present example embodiment, when a pre-encryption file has been saved on the file server 13, the management server 11 does not encrypt the file by itself, but instructs the encryption terminal 15 to encrypt the file. This prevents files from being taken from the file server 13 to an external environment (the management server 11), even if the management server 11 is a management server in an external environment such as a cloud service, thereby improving confidentiality.

### <Modified Example of Encryption System 1>

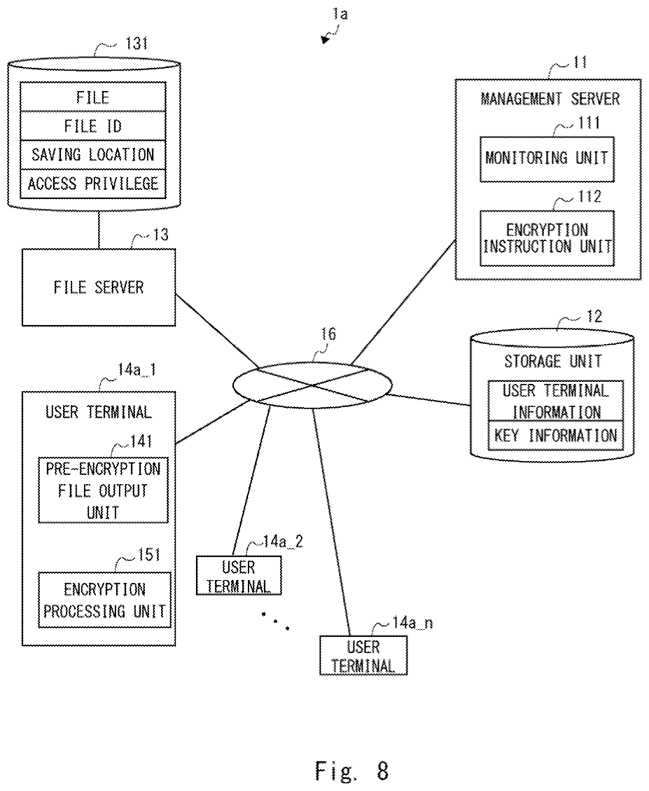

FIG. 8 is a block diagram showing a modified example of the encryption system 1 as an encryption system 1a. Compared with the encryption system 1, the encryption system 1a does not include the encryption terminals 15 but includes n-number of user terminals 14a instead of the n-numbers of user terminals 14. In the following, the n-number of user terminals 14a are referred to as user terminals 14a_1 to 14a_n to distinguish them from each other.

Each of the user terminals 14a_1 to 14a_n includes an encryption processing unit 151 provided in the encryption terminal 15. In other words, in the present example embodiment, each of the user terminals 14a_1 to 14a_n has the function of the encryption terminal 15. The other configurations of the encryption system 1a are similar to those of the encryption system 1, and the description thereof is omitted.

### (Operation of Encryption System 1a)

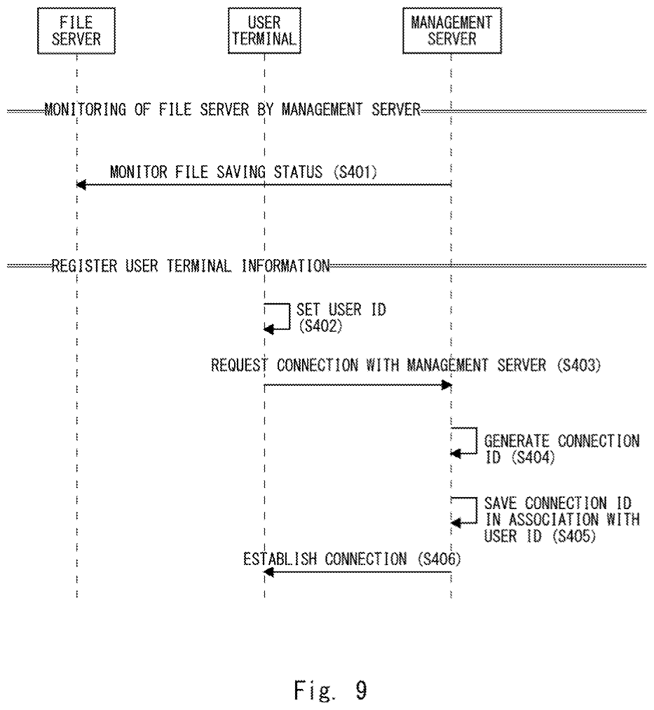

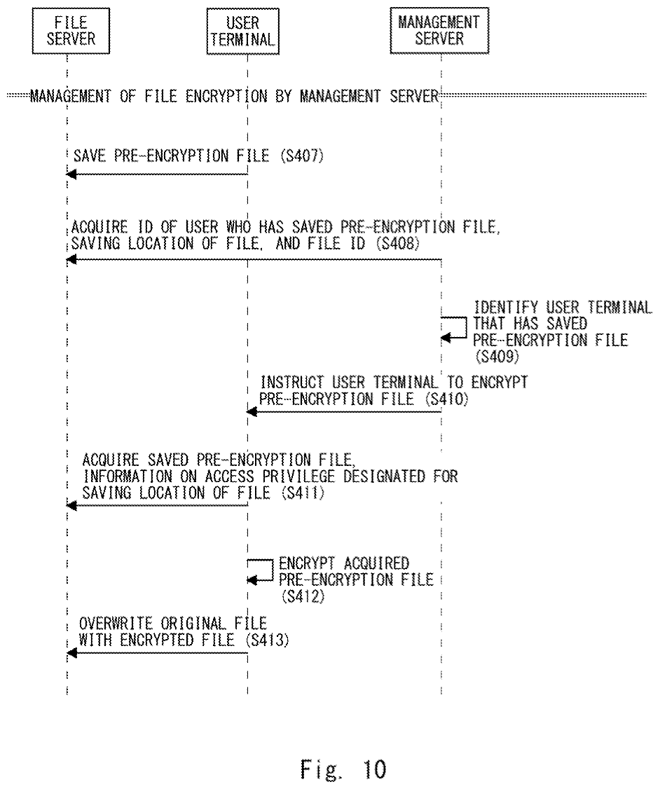

An operation of the encryption system 1a is described with reference to FIGS. 9 and 10, in addition to FIG. 8. FIGS. 9 and 10 are sequence diagrams showing a processing procedure of the encryption system 1a.

First, the process in step S401, which is the monitoring process of the file server 13 by the management server 11, is the same as the process in step S301, and the description thereof is omitted. The process in steps S402 to S406, which is the process for registering user terminal information, is similar to the process in steps S302 to S306, and the description thereof is omitted.

Next, a process of “management of file encryption by the management server 11” is described.

The following description is an example in which a user U1 has saved, via the user terminal 14a_1, a pre-encryption file f1_pre in a folder FD1, which is a part of the storage area managed by the file server 13.

First, the user U1 saves, via the user terminal 14a_1, the pre-encryption file f1_pre in the folder FD1, which is a part of the storage area managed by the file server 13 (step S407).

When detecting that a pre-encryption file has been saved in the storage area 131 managed by the file server 13, the management server 11 acquires the ID of the user who has saved the file, the saving location of the file, and the file ID (step S408).

In this example, the management server 11 acquires the ID of the file f1_pre as the file ID, information on the folder FD1 as the saving location of the file f1_pre, and the ID of the user U1 as the ID of the user who has saved the file f1_pre.

Then, the management server 11 identifies the user terminal 14a_1 from the ID of the user who has saved the file f1_pre (step S409). Then, the management server 11 instructs the identified user terminal 14a_1 to encrypt the file f1_pre (step S410). At this time, the management server 11 also transmits the encryption key for encrypting the file f1_pre to the user terminal 14a_1.

When receiving the instruction to encrypt the file f1_pre, the user terminal 14a_1 acquires the file f1_pre and information on the access privilege designated for the folder FD1, which is the saving location of the file f1_pre, from the file server 13 (step S411). Note that if the user terminal 14_1 stores the pre-encryption file f1_pre on its own terminal, it is not necessary to acquire the file f1_pre from the file server 13.

Then, the user terminal 14a_1 encrypts the file f1_pre acquired from the file server 13 with the encryption key received from the management server 11 (step S412). In this example, the user terminal 14a_1 encrypts the file f1_pre to generate an encrypted file f1.

Then, the user terminal 14a_1 outputs the encrypted file f1 to the folder FD1, which is the storage source of the pre-encryption file f1_pre. The pre-encryption file f1_pre is thereby rewritten by the encrypted file f1 (step S413).

In this manner, the encryption system 1a can achieve an effect similar to the encryption system 1.

The present example embodiment has been described as an example in which the user terminal 14a_1, which has saved the pre-encryption file f1_pre in the storage area 131, encrypts the file f1_pre, but is not limited thereto. If there is a plurality of user terminals 14a_1 to 14a_n (that is, n is 2 or more), any of the user terminals 14a_2 to 14a_n other than the user terminal 14a_1, which has saved the file f1_pre in the storage area 131, may encrypt the file f1_pre. In this case, the encryption instruction unit 112 provided in the management server 11 instructs, for example, any of the user terminals 14a_2 to 14a_n determined to be related to the user terminal 14a_1 to encrypt the file f1_pre. Note that the relevance between the terminals is determined based on, for example, the installation area of the terminals and the affiliation of the users who use the terminals. This enables the file f1_pre to be encrypted by any of the user terminals 14a_2 to 14a_n even if the user terminal 14a_1, which has saved the pre-encryption file f1_pre in the storage area 131, is turned off.

Alternatively, the encryption instruction unit 112 provided in the management server 11 may instruct, for example, a user terminal determined to require the shortest time to encrypt the file f1_pre among the user terminals 14 a_1 to 14a_n to encrypt the file f1_pre. The time required for encryption is determined based on, for example, the distance of the network segment between the file server and the user terminal. This reduces the load on the encryption system 1.

In contrast, the encryption system 1 shown in FIG. 5 does not need to provide an encryption processing function for each of the user terminals 14a_1 to 14a_n by providing the encryption terminal 15. In addition, it is possible to reduce the number of connected terminals managed by the management server 11.

### Third Example Embodiment

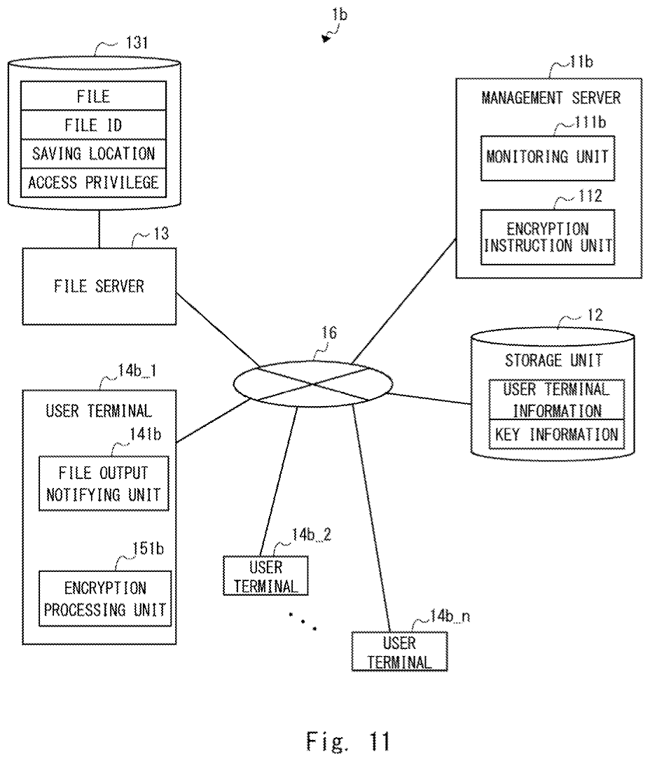

FIG. 11 is a block diagram showing a configuration example of an encryption system 1b according to a third example embodiment. Compared with the encryption system 1a, the encryption system 1b includes a management server 11b instead of the management server 11, and n-number of user terminals 14b instead of the n-number of user terminals 14a. In the following, the n-number of user terminals 14b are referred to as user terminals 14b_1 to 14b_n to distinguish them from each other.

Each of the user terminals 14b_1 to 14b_n includes a file output notifying unit 141b instead of the pre-encryption file output unit 141. That is, in each of the user terminals 14b_1 to 14b_n, the file output notifying unit 141b does not output a pre-encryption file to a storage area of a file server 13, but only transmits, to the management server 11, a notice that a file is to be saved in the storage area of the file server 13. Therefore, a pre-encryption file is not saved in the storage area 131 managed by the file server 13.

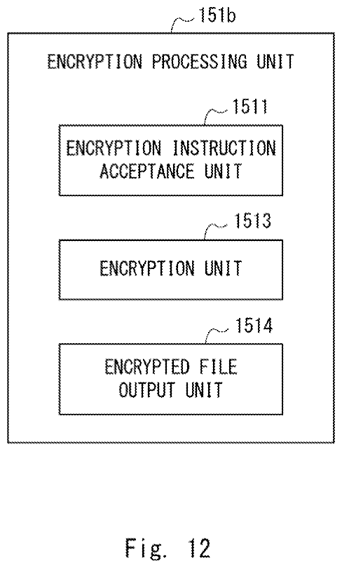

In addition, each of the user terminals 14B_1 to 14B_n includes an encryption processing unit 151b instead of the encryption processing unit 151. FIG. 12 is a block diagram showing a configuration example of the encryption processing unit 151b. Referring to FIG. 12, the encryption processing unit 151b includes no acquisition unit 1512 since the encryption processing unit 151b does not need to acquire a pre-encryption file from the file server 13. The other configurations of the encryption processing unit 151b are similar to those of the encryption processing unit 151, and the description thereof is omitted.

The management server 11b includes a monitoring unit 111b instead of the monitoring unit 111. The monitoring unit 111b monitors whether a notice of file saving has been transmitted by any of the user terminals 14b_1 to 14b_n. Then, when the monitoring unit 111b detects that the notice of file saving has been transmitted by any of the user terminals 14b_1 to 14b_n, the encryption instruction unit 112 instructs the user terminal that has transmitted the notice of file saving to encrypt a pre-encryption file. At this time, the encryption instruction unit 112 also transmits the encryption key for encrypting the pre-encryption file to the user terminal that has transmitted the notice of file saving.

The user terminal that has transmitted the notice of file saving encrypts the pre-encryption file and outputs it to the storage area 131 of the file server 13. This saves the encrypted file in the storage area 131 managed by the file server 13.

The other configurations of the encryption system 1b are similar to those of the encryption system 1a, and the description thereof is omitted.

### (Operation of Encryption System 1b)

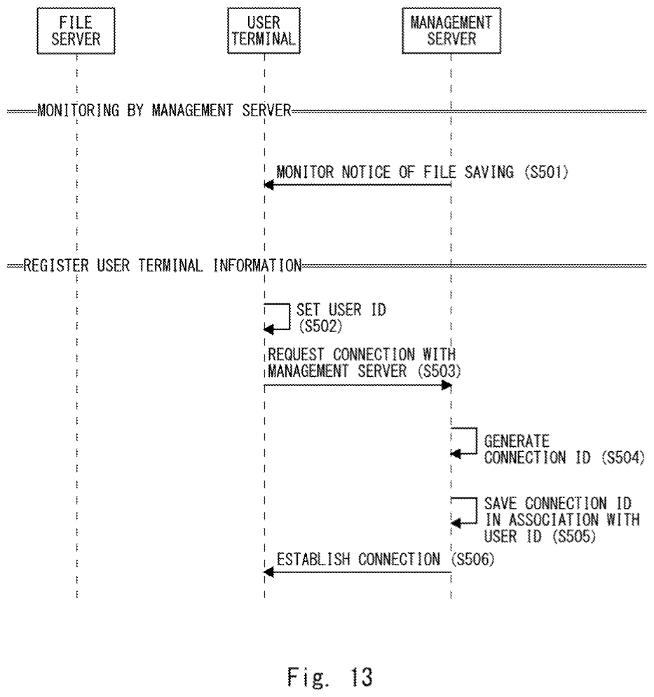

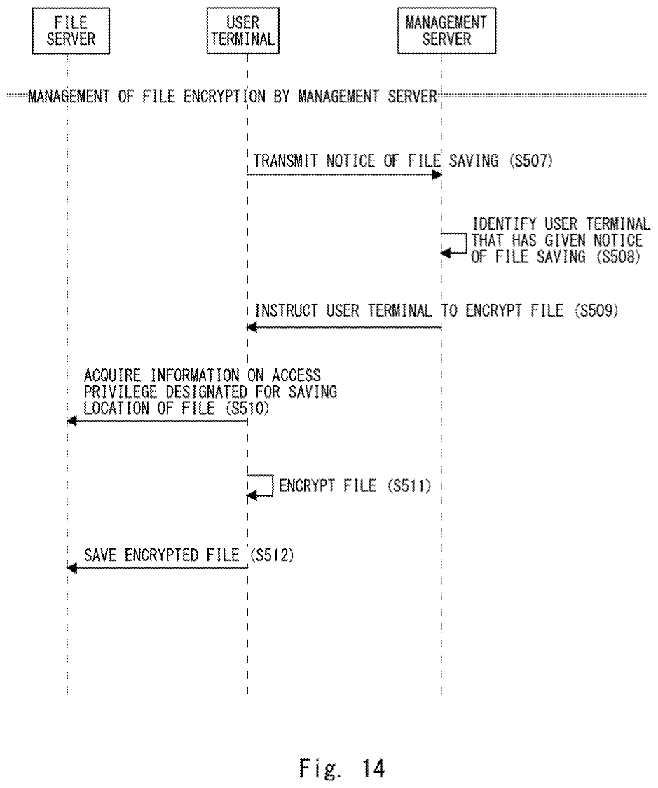

Next, an operation of the encryption system 1b is described with reference to FIGS. 13 and 14, in addition to FIGS. 11 and 12. FIGS. 13 and 14 are sequence diagrams showing a processing procedure of the encryption system 1b.

First, a process of “monitoring by the management server 11b” is described.

The management server 11b monitors whether a notice of file saving has been transmitted by any of the user terminals 14b_1 to 14b_n during startup (step S501).

Next, a process of “registration of user terminal information” is described. The process in steps S502 to S506, which is the process for registering user terminal information, is similar to the process in steps S402 to S406, and the description thereof is omitted.

Next, a process of “management of file encryption by the management server 11” is described.

The following is an example in which a user U1 saves, via a user terminal 14b_1, an encrypted file f1 in a folder FD1, which is a part of the storage area 131 managed by the file server 13.

First, the user U1 transmits a notice of file saving to the management server 11b via the user terminal 14b_1 (step S507).

When detecting the notice of file saving, the management server 11b identifies the user terminal 14b_1 that has transmitted the notice (step S508), and then instructs the identified user terminal 14b_1 to encrypt a pre-encryption file f1_pre (step S509). At this time, the management server 11b also transmits the encryption key for encrypting the pre-encryption file f1_pre to the identified user terminal 14b_1.

When receiving the instruction to encrypt the file f1_pre, the user terminal 14b_1 acquires, from the file server 13, information on the access privilege designated for the folder FD1 in which a file is to be saved (step S510).

Then, the user terminal 14b_1 encrypts the pre-encryption file f1_pre stored on its own terminal with the encryption key received from the management server 11b (step S511). In this example, the user terminal 14b_1 encrypts the file f1_pre to generate an encrypted file f1.

Then, the user terminal 14b_1 outputs the encrypted file f1 to the folder FD1. The encrypted file f1 is thereby saved in the folder FD1 (step S512).

In this manner, in this encryption system 1b according to the present example embodiment, when a notice of file saving has been transmitted by any of the user terminals 14b_1 to 14b_n, the management server 11b instructs the user terminal that has transmitted the notice to encrypt the file. This prevents files from being taken from the file server 13 to an external environment (the management server 11b), even if the management server 11b is a management server in an external environment such as a cloud service, thereby improving confidentiality. In the present example embodiment, it is not necessary to save a pre-encryption file in the storage area 131 of the file server 13, and confidentiality is further improved.

The present disclosure can also be achieved by the CPU executing a computer program to perform any process described as a hardware process.

In the above examples, the program can be stored by various types of non-transitory computer-readable media and provided to a computer. Non-transitory computer-readable media include any type of tangible storage media. Examples of non-transitory computer-readable media include magnetic storage media (such as flexible disks, magnetic tapes, and hard disk drives), optical magnetic storage media (such as magneto-optical disks). In addition, examples of non-transitory computer-readable media include Compact Disc Read Only Memory (CD-ROM), CD-R, CD-R/W, Digital Versatile Disc (DVD), and semiconductor memories (such as mask ROM, Programmable ROM (PROM), Erasable PROM (EPROM), flash ROM, and Random Access Memory (RAM)). Tre program may be provided to a computer using any type of transitory computer-readable media. Examples of transitory computer-readable media include electric signals, optical signals, and electromagnetic waves. Transitory computer readable media can provide the program to a computer through a wired communication line (such as electric wires, and optical fibers) or a wireless communication line.

A part or all of the above example embodiments may be described as the following Supplementary notes but are not limited to the following.

### (Supplementary Note 1)

A management device comprising:
a monitoring means for monitoring whether a file before encryption has been saved in a storage area managed by a file server; and
an encryption instruction means for instructing, when the monitoring means detects that the file before encryption has been saved in the storage area, an encryption terminal to encrypt the file.

### (Supplementary Note 2)

The management device described in Supplementary note 1, wherein the encryption instruction means transmits an encryption key for encrypting the file to the encryption terminal when instructing the encryption terminal to encrypt the file.

### (Supplementary Note 3)

The management device described in Supplementary note 1 or 2, wherein the encryption terminal is a user terminal that has saved the file before encryption in the storage area.

### (Supplementary Note 4)

The management device described in any one of Supplementary notes 1 to 3, wherein
the encryption terminal is each of a plurality of user terminals including the user terminal that has saved the file before encryption in the storage area, and
the encryption instruction means instructs any one of the plurality of user terminals to encrypt the file.

### (Supplementary Note 5)

The management device described in Supplementary note 4, wherein the encryption instruction means instructs, among the plurality of user terminals, a user terminal determined to require the shortest time to encrypt the file to encrypt the file.

### (Supplementary Note 6)

The management device described in Supplementary note 4, wherein the encryption instruction means instructs, among the plurality of user terminals, another user terminal determined to be related to the user terminal that has saved the file before encryption in the storage area to encrypt the file.

### (Supplementary Note 7)

An encryption system comprising:
a file server;
an encryption terminal; and
the management device described in any one of Supplementary notes 1 to 6,
wherein the management device instructs, when a file before encryption has been saved in a storage area managed by the file server, the encryption terminal to encrypt the file.

### (Supplementary Note 8)

The encryption system described in Supplementary note 7, wherein
the encryption terminal comprises:
   an instruction acceptance means for accepting an instruction to encrypt the file transmitted together with an encryption key from the management device;
   a file acquisition means for acquiring the file from the file server;
   an encryption means for encrypting the file with the encryption key; and
   a file output means for rewriting the file before encryption saved in the storage area to the file encrypted by the encryption means.

### (Supplementary Note 9)

An encryption terminal comprising:
an instruction acceptance means for accepting, in response to a file before encryption having been saved in a storage area managed by a file server, an instruction to encrypt the file transmitted together with an encryption key from a management device;
a file acquisition means for acquiring the file from the file server;
an encryption means for encrypting the file with the encryption key; and
a file output means for rewriting the file before encryption saved in the storage area to the file encrypted by the encryption means.

### (Supplementary Note 10)

The encryption terminal described in Supplementary note 9, wherein the encryption terminal is a user terminal that has saved the file before encryption in the storage area.

### (Supplementary Note 11)

A management device comprising:
a monitoring means for monitoring whether a user terminal has transmitted a notice that a file is to be saved in a storage area managed by a file server; and
an encryption instruction means for instructing, when the monitoring means detects the user terminal has transmitted the notice, the user terminal to encrypt the file after transmitting an encryption key for encrypting the file.

### (Supplementary Note 12)

An encryption system comprising:
a file server;
a user terminal; and
the management device described in Supplementary note 11,
wherein the management device instructs, when the user terminal has transmitted a notice that a file is to be saved in a storage area managed by the file server, the user terminal to encrypt the file.

### (Supplementary Note 13)

The encryption system described in Supplementary note 12, wherein
the user terminal comprises:
   a notifying means for transmitting a notice that the file is to be saved in the storage area managed by the file server;
   an instruction acceptance means for accepting an instruction to encrypt the file transmitted together with an encryption key from the management device in response to the notice transmitted by the notifying means;
   an encryption means for encrypting the file with the encryption key; and
   a file output means for saving the file encrypted by the encryption means in the storage area.

### (Supplementary Note 14)

A user terminal comprising:
a notifying means for transmitting a notice that a file is to be saved in a storage area managed by a file server;
an instruction acceptance means for accepting an instruction to encrypt the file transmitted together with an encryption key from the management device in response to the notice transmitted by the notifying means;
an encryption means for encrypting the file with the encryption key; and
a file output means for saving the file encrypted by the encryption means in the storage area.

### (Supplementary Note 15)

A management method comprising:
a monitoring step of monitoring whether a file before encryption has been saved in a storage area managed by a file server; and
an encryption instruction step of instructing, when it is detected that the file before encryption has been saved in the storage area in the monitoring step, an encryption terminal to encrypt the file.

### (Supplementary Note 16)

The management method described in Supplementary note 15, wherein the encryption instruction step includes transmitting an encryption key for encrypting the file to the encryption terminal when instructing the encryption terminal to encrypt the file.

### (Supplementary Note 17)

An encryption method comprising:
an instruction acceptance step of accepting, in response to a file before encryption having been saved in a storage area managed by a file server, an instruction to encrypt the file transmitted together with an encryption key from a management device;
a file acquisition step of acquiring the file from the file server;
an encryption step of encrypting the file with the encryption key; and
a file output step of rewriting the file before encryption saved in the storage area to the file encrypted in the encryption step.

### (Supplementary Note 18)

A non-transitory computer-readable medium storing a program to execute:
a monitoring process of monitoring whether a file before encryption has been saved in a storage area managed by a file server; and
an encryption instruction process of instructing, when it is detected that the file before encryption has been saved in the storage area in the monitoring process, an encryption terminal to encrypt the file.

### (Supplementary Note 19)

The non-transitory computer-readable medium storing the program described in Supplementary note 18, wherein the encryption instruction process includes transmitting an encryption key for encrypting the file to the encryption terminal when instructing the encryption terminal to encrypt the file.

### (Supplementary Note 20)

A non-transitory computer-readable medium storing a program to execute:
an instruction acceptance process of accepting, in response to a file before encryption having been saved in a storage area managed by a file server, an instruction to encrypt the file transmitted together with an encryption key from a management device;
a file acquisition process of acquiring the file from the file server;
an encryption process of encrypting the file with the encryption key; and
a file output process of rewriting the file before encryption saved in the storage area to the file encrypted in the encryption process.

### (Supplementary Note 21)

A management method comprising:
a monitoring step of monitoring whether a user terminal has transmitted a notice that a file is to be saved in a storage area managed by a file server; and
an encryption instruction step of instructing, when the notice by the user terminal is detected in the monitoring step, the user terminal to encrypt the file after transmitting an encryption key for encrypting the file.

### (Supplementary Note 22)

An encryption method comprising:
a notice step of giving notice that a file is to be saved in a storage area managed by a file server, and
an instruction acceptance step of accepting an instruction to encrypt the file transmitted together with an encryption key from a management device in response to the notice;
an encryption step of encrypting the file with the encryption key; and
a file output step of saving the file encrypted in the encryption step in the storage area.

### (Supplementary Note 23)

A non-transitory computer-readable medium storing a program to execute:
a monitoring process of monitoring whether a user terminal has transmitted a notice that a file is to be saved in a storage area managed by a file server; and
an encryption instruction process of instructing, when the notice by the user terminal is detected in the monitoring process, the user terminal to encrypt the file after transmitting an encryption key for encrypting the file.

### (Supplementary Note 24)

A non-transitory computer-readable medium storing a program to execute:
a notice process of giving notice that a file is to be saved in a storage area managed by a file server;
an instruction acceptance process of accepting an instruction to encrypt the file transmitted together with an encryption key from a management device in response to the notice;
an encryption process of encrypting the file with the encryption key; and
a file output process of saving the file encrypted in the encryption process in the storage area.

Although the invention has been described above with reference to the example embodiments, the invention is not limited to the above example embodiments. Various changes can be made in the configuration and details of the present invention that can be understood by those skilled in the art within the scope of the present invention.

### REFERENCE SIGNS LIST

1 Encryption system
1a Encryption system
1b Encryption system
11 Management server
11b Management server
12 Storage unit
13 File server
14 User terminal
14a User terminal
14b User terminal
14_1 to 14_n User terminal
14a_1 to 14a_n User terminal
14b_1 to 14b_n User terminal
15 Encryption terminal
16 Network
111 Monitoring unit
111b Monitoring unit
112 Encryption instruction unit
131 Storage area
141 pre-encryption file output unit
141b File output notifying unit
151 Encryption processing unit
151b Encryption processing unit
1511 Encryption instruction acceptance unit
1512 Pre-encryption file acquisition unit
1513 Encryption unit
1514 Encrypted file output unit

What is claimed is:

1. A management device comprising:
at least one first memory storing program instructions; and
at least one first processor configured to execute the instructions stored in the memory to:
monitor whether a file before encryption has been saved in a storage area managed by a file server; and
instruct, when the file before encryption saved in the storage area is detected, an encryption terminal to encrypt the file.

2. The management device according to claim 1, wherein in the encryption instruction, an encryption key for encrypting the file is transmitted to the encryption terminal when instructing the encryption terminal to encrypt the file.

3. The management device according to claim 1, wherein the encryption terminal is a user terminal that has saved the file before encryption in the storage area.

4. The management device according to claim 1, wherein
the encryption terminal is each of a plurality of user terminals including the user terminal that has saved the file before encryption in the storage area, and
in the encryption instruction, any one of the plurality of user terminals is instructed to encrypt the file.

5. The management device according to claim 4, wherein in the encryption instruction, among the plurality of user terminals, a user terminal determined to require the shortest time to encrypt the file is instructed to encrypt the file.

6. The management device according to claim 4, wherein in the encryption instruction, among the plurality of user terminals, another user terminal determined to be related to the user terminal that has saved the file before encryption in the storage area is instructed to encrypt the file.

7. An encryption system comprising:
a file server;
an encryption terminal; and
the management device according to claim 1,
wherein the management device instructs, when a file before encryption has been saved in a storage area managed by the file server, the encryption terminal to encrypt the file.

8. The encryption system according to claim 7, wherein
the encryption terminal comprises:
at least one second memory storing program instructions; and
at least one second processor configured to execute the instructions stored in the memory to:
accept an instruction to encrypt the file transmitted together with an encryption key from the management device;
acquire the file from the file server;
encrypt the file with the encryption key; and
rewrite the file before encryption saved in the storage area to the encrypted file.

9. An encryption terminal comprising:
at least one memory storing program instructions; and
at least one processor configured to execute the instructions stored in the memory to:
accept, in response to a file before encryption having been saved in a storage area managed by a file server, an instruction to encrypt the file transmitted together with an encryption key from a management device;
acquire the file from the file server;
encrypt the file with the encryption key; and
rewrite the file before encryption saved in the storage area to the encrypted file.

10. The encryption terminal according to claim 9, wherein the encryption terminal is a user terminal that has saved the file before encryption in the storage area.

11-14. (canceled)

15. A management method comprising:
monitoring whether a file before encryption has been saved in a storage area managed by a file server; and
instructing, when it is detected that the file before encryption has been saved in the storage area, an encryption terminal to encrypt the file.

16. The management method according to claim 15, wherein the encryption instruction includes transmitting an encryption key for encrypting the file to the encryption terminal when instructing the encryption terminal to encrypt the file.

17. (canceled)

18. A non-transitory computer-readable medium storing a program to execute:
a monitoring process of monitoring whether a file before encryption has been saved in a storage area managed by a file server; and
an encryption instruction process of instructing, when it is detected that the file before encryption has been saved in the storage area in the monitoring process, an encryption terminal to encrypt the file.

19. The non-transitory computer-readable medium storing the program according to claim 18, wherein the encryption instruction process includes transmitting an encryption key for encrypting the file to the encryption terminal when instructing the encryption terminal to encrypt the file.

20. (canceled)
